(19) United States
(12) Patent Application Publication
(10) Pub. No.: US 2013/0130640 A1
(43) Pub. Date: May 23, 2013

(54) APPARATUS AND METHOD FOR IDENTIFYING LOSS OF PORTABLE TERMINAL IN WIRELESS COMMUNICATION SYSTEM

(71) Applicant: Samsung Electronics Co., Ltd, Gyeonggi-do (KR)

(72) Inventors: Eun-Seok Yang, Seoul (KR); Sung-Kyu Chang, Seoul (KR)

(73) Assignee: SAMSUNG ELECTRONICS CO., LTD, Gyeonggi-do (KR)

(21) Appl. No.: 13/678,337

(22) Filed: Nov. 15, 2012

(30) Foreign Application Priority Data
Nov. 17, 2011 (KR) 10-2011-0120038

(51) Int. Cl. H04W 60/00; H04W 4/22

(52) U.S. Cl. CPC H04W 60/00; H04W 4/22
USPC 455/404.1; 455/435.1

(57) ABSTRACT

An apparatus and method identify a loss of a portable terminal in a wireless communication system. A method for identifying a loss of a portable terminal by a control server in a wireless communication system includes receiving a user identifier from the portable terminal, identifying registration information of the portable terminal, and determining that the portable terminal is lost, when the user identifier received from the portable terminal is different from the registration information of the portable terminal.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Nov. 17, 2011 and assigned Serial No. 10-2011-0120038, the contents of which are incorporated herein by reference.

### TECHNICAL FIELD OF THE INVENTION

The present disclosure relates generally to an apparatus and method for a portable terminal in a wireless communication system, and in particular, to an apparatus and method for identifying a loss of a portable terminal in a wireless communication system.

### BACKGROUND OF THE INVENTION

With the development of mobile communication technologies, portable terminals are being used as essential personal communication equipment.

Portable terminals are evolving into multimedia devices that provide a personal information management service, which enables users to input/manage contact addresses, phone numbers, schedules, memos, and the like, in addition to a simple voice call service.

As described above, portable terminals are always carried by users. Therefore, the portable terminals are at high risk of being lost, and are frequently lost in reality.

When portable terminals are lost, personal information stored in the portable terminals may leak to other persons, or the lost portable terminals may be used by other persons for wrong purposes.

### SUMMARY OF THE INVENTION

To address the above-discussed deficiencies of the prior art, it is a primary object to provide an apparatus and method for identifying a loss of a portable terminal in a wireless communication system.

Another object of the present disclosure is to provide an apparatus and method for identifying a loss of a portable terminal in a wireless communication system by using matching information on a user identifier and a terminal identifier of the portable terminal.

Yet another object of the present disclosure is to provide an apparatus and method for identifying a loss of a portable terminal by the portable terminal in a wireless communication system by using matching information on a user identifier and a terminal identifier.

Yet another object of the present disclosure is to provide an apparatus and method for notifying loss information of a portable terminal to an emergency communication network in a wireless communication system.

Yet another object of the present disclosure is to provide an apparatus and method for notifying loss information of a portable terminal to an emergency communication network in a wireless communication system by using unstructured supplementary service data (USSD).

According, to an aspect of the present disclosure, a method for identifying a loss of a portable terminal by a control server in a wireless communication system includes: receiving a user identifier from the portable terminal; identifying registration information of the portable terminal; and determining that the portable terminal is lost, when the user identifier received from the portable terminal is different from the registration information of the portable terminal.

According to another aspect of the present disclosure, a method for identifying a loss of a portable terminal by the portable terminal in a wireless communication system includes: identifying a user identifier of the portable terminal; identifying registration information of the portable terminal; and determining that the portable terminal is lost, when the user identifier is different from the registration information of the portable terminal.

According to yet another aspect of the present disclosure, an apparatus for identifying a loss of a portable terminal by a control server in a wireless communication system includes: a communication interface for receiving a user identifier from the portable terminal; a storage unit for storing registration information of the portable terminal; and a control unit for determining that the portable terminal is lost, when the user identifier received from the portable terminal through the communication interface is different from the registration information of the portable terminal stored in the storage unit.

According to yet another aspect of the present disclosure, an apparatus for identifying a loss of a portable terminal by the portable terminal in a wireless communication system includes: a storage unit for storing registration information of the portable terminal; and a control unit for identifying a user identifier of the portable terminal and determining that the portable terminal is lost, when the user identifier is different from the registration information of the portable terminal stored in the storage unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process for registering user information according to an exemplary embodiment of the present disclosure;

FIG. 2 illustrates a process for identifying terminal information by a portable terminal according to an exemplary embodiment of the present disclosure;

FIG. 3 illustrates a process for identifying the loss/non-loss of a portable terminal by a control server according to an exemplary embodiment of the present disclosure;

FIG. 4 illustrates a process for identifying the loss/non-loss of a portable terminal by a control server according to another exemplary embodiment of the present disclosure;

FIG. 5 illustrates a process for identifying the loss/non-loss of a portable terminal by the portable terminal according to an exemplary embodiment of the present disclosure;

FIG. 6 illustrates a process for providing a loss management service by a control server according to an exemplary embodiment of the present disclosure;

FIG. 7 illustrates a process for providing a loss management service by a portable terminal according to an exemplary embodiment of the present disclosure;

FIG. 8 illustrates a block diagram of a portable terminal according to the present disclosure; and

FIG. 9 illustrates a block diagram of a control server according to the present disclosure.

### DETAILED DESCRIPTION OF THE INVENTION

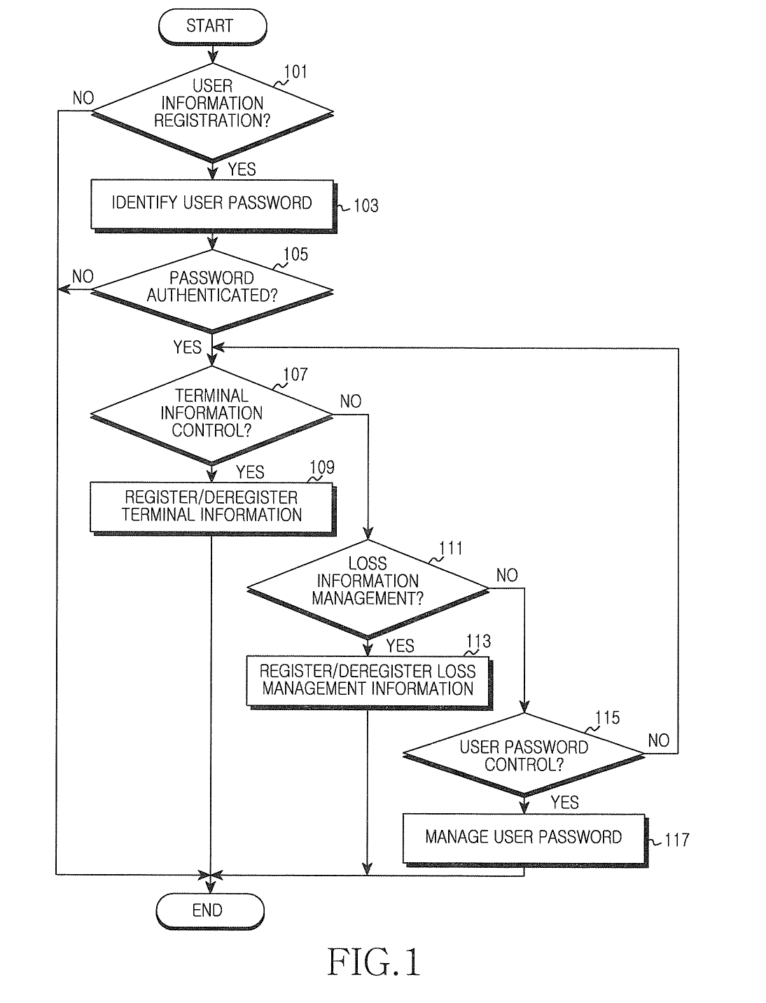

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged. Exemplary embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein should be understood based on the descriptions made herein.

Hereinafter, a description will be given of a scheme for identifying a loss of a portable terminal in a wireless communication system according to the present disclosure.

In the following description, examples of a portable terminal include a mobile terminal, a personal digital assistant (PDA), a laptop computer, a smart phone, a netbook, a mobile internet device (MID), an ultra mobile personal computer (UMPC), a tablet PC, and the like.

The following description will be made on the assumption that a control server and a portable terminal communicate with each other by using unstructured supplementary service data (USSD). However, the control server and the portable terminal may also communicate with each other by using other types of messages. Herein, the control server performs a function of identifying a loss of the portable terminal.

In the following description, a wireless communication system identifies the loss/non-loss of a portable terminal by using matching information on a terminal identifier of the portable terminal and a user identifier of the portable terminal. For example, the terminal identifier of the portable terminal and the user identifier of the portable terminal are registered to a service provider when a service request of the portable terminal is made to the service provider. As another example, a user of the portable terminal may register the user identifier and the terminal identifier of the portable terminal to the control server through the Web as illustrated in FIG. 1. Herein, the terminal identifier includes an international mobile equipment identity (IMEI), and the user identifier includes an international mobile subscriber identity (IMSI).

FIG. 1 illustrates a process for registering user information according to an exemplary embodiment of the present disclosure. The following description will be made on the assumption that a user registers a terminal identifier and a user identifier to a control server through a portable terminal.

Referring to FIG. 1, in step 101, the portable terminal determines whether a user information registration event occurs. For example, the portable terminal determines whether a user information registration menu is selected by the user. As another example, the portable terminal determines whether a service code for user information registration is input by the user.

When a user information registration event occurs, the portable terminal proceeds to step 103. In step 103, the portable terminal identifies a user password input by the user. For example, when a user information registration event occurs, the portable terminal displays a password input window on a display unit. Thereafter, the portable terminal identifies a user password that is input by the user through the password input window displayed on the display unit.

In step 105, the portable terminal determines whether the user password input by the user is authenticated.

When the user password input by the user is not authenticated, the portable terminal determines that the user inputting the user password has no right to register user information. Accordingly, the portable terminal ends the present algorithm.

On the other hand, when the user password input by the user is authenticated, the portable terminal determines that the user inputting the user password has the right to register user information. Accordingly, in step 107, the portable terminal determines whether a terminal information control menu is selected by the user.

When the terminal information control menu is selected by the user, the portable terminal proceeds to step 109. In step 109, the portable terminal registers a terminal identifier and a user identifier, which are used to identify the loss/non-loss of the portable terminal, to the control server according to a user operation. As another example, according to a user operation, the portable terminal may change a terminal identifier and a user identifier that are registered in the control server. As yet another example, according to a user operation, the portable terminal may delete a terminal identifier and a user identifier that are registered in the control server.

On the other hand, when the terminal information control menu is not selected by the user (in step 107), the portable terminal proceeds to step 111. In step 111, the portable terminal determines whether a loss information management menu is selected by the user.

When the loss information management menu is selected by the user, the portable terminal proceeds to step 113. In step 113, the portable terminal registers information on an emergency communication network, which is used to transmit loss information of the portable terminal, to the control server according to a user operation. As another example, according to a user operation, the portable terminal may change emergency communication network information registered in the control server. As yet another example, according to a user operation, the portable terminal may delete emergency communication network information registered in the control server.

On the other hand, when the loss information management menu is not selected by the user (in step 111), the portable terminal proceeds to step 115. In step 115, the portable terminal determines whether a user password control menu is selected by the user.

When the user password control menu is not selected by the user, the portable terminal returns to step 107 and determines again whether the terminal information control menu is selected by the user.

On the other hand, when the user password control menu is selected by the user (in step 115), the portable terminal proceeds to step 117. In step 117, the portable terminal registers a user password for a user information registration right according to a user operation. As another example, according to a user operation, the portable terminal may change a user password registered in the control server. As yet another example, according to a user operation, the portable terminal may change a user password registered in the control server.

Thereafter, the portable terminal ends the present algorithm.

As described above, the portable terminal may manage at least one of terminal information, loss management information, and a user password by a user operation.

In the above exemplary embodiment, the portable terminal registers at least one of terminal information, loss management information, and a user password to the control server by a user operation.

In another exemplary embodiment, by a user operation, the portable terminal may register at least one of terminal information, loss management information, and a user password to a separate server different from the control server.

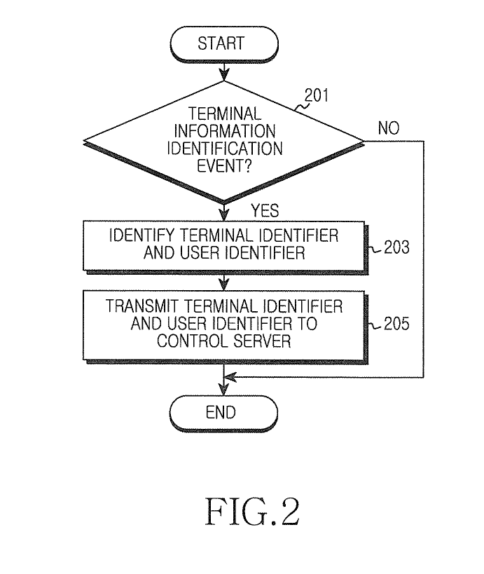

As illustrated in FIG. 2, the portable terminal transmits the terminal identifier and the user identifier to the control server so that the control server can identify the loss/non-loss of the portable terminal.

FIG. 2 illustrates a process for identifying terminal information by the portable terminal according to an exemplary embodiment of the present disclosure.

Referring to FIG. 2, in step 201, the portable terminal determines whether a terminal information identification event occurs. For example, the portable terminal determines whether a terminal information transmission period arrives. In this case, when a terminal information transmission period arrives, the portable terminal determines that a terminal information identification event occurs. As another example, the portable terminal may determine whether the control server requests terminal information. In this case, when the control server requests terminal information, the portable terminal determines that a terminal information identification event occurs. As yet another example, the portable terminal may determine whether the power is on. In this case, when the power is newly turned on, the portable terminal determines that a terminal information identification event occurs. As yet another example, the portable terminal may determine whether a subscriber identification module (SIM) card is changed. In this case, when the SIM card is changed, the portable terminal determines that a terminal information identification event occurs.

When a terminal information identification event occurs, the portable terminal proceeds to step 203. In step 203, the portable terminal identifies a terminal identifier and a user identifier of a user that currently uses the portable terminal. For example, through a SIM card inserted into the portable terminal, the portable terminal may identify a user identifier of a user that currently uses the portable terminal.

Thereafter, in step 205, the portable terminal transmits the terminal identifier and the user identifier identified in step 203 to the control server.

Thereafter, the portable terminal ends the present algorithm.

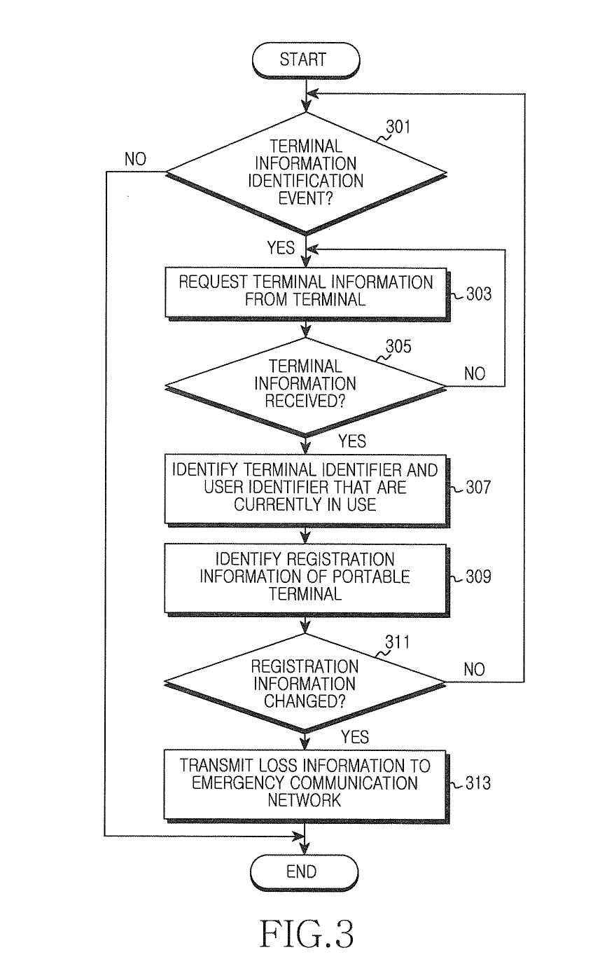

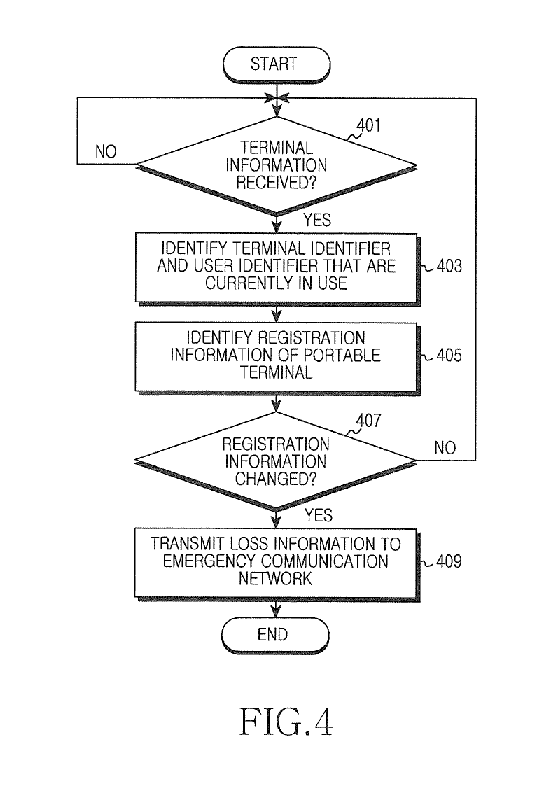

When the portable terminal transmits the terminal identifier and the user identifier as described above, the control server identifies the loss/non-loss of the portable terminal as illustrated in FIG. 3 or 4.

FIG. 3 illustrates a process for identifying the loss/non-loss of a portable terminal by the control server according to an exemplary embodiment of the present disclosure.

Referring to FIG. 3, in step 301, the control server determines whether a terminal information identification event occurs. For example, the control server determines whether a terminal information transmission period of the portable terminal arrives. As another example, the control server may determine whether a loss identification menu of the portable terminal is selected.

When a terminal information identification event occurs, the control server proceeds to step 303. In step 303, the control server requests terminal information from the portable terminal. Herein, the terminal information includes a terminal identifier of the portable terminal and a user identifier of the portable terminal.

In step 305, the control server determines whether terminal information is received from the portable terminal.

When terminal information is not received within a predetermined time, the control server returns to step 303 and requests terminal information from the portable terminal again. For example, when terminal information is not received within a predetermined time after the terminal information request to the portable terminal, the control server detects the number of times of terminal information requests to the portable terminal. When the number of times of terminal information requests is smaller than or equal to a predetermined number of times, the control server returns to step 303 and requests terminal information from the portable terminal again. On the other hand, when the number of times of terminal information requests is greater than the predetermined number of times, the control server determines that the communication with the portable terminal is disconnected, and ends the present algorithm. Herein, when receiving the terminal information from the portable terminal, the control server initializes the number of times of terminal information requests.

On the other hand, when terminal information is received from the portable terminal, the control server proceeds to step 307. In step 307, the control server identifies a user identifier and a terminal identifier of the portable terminal through the terminal information received from the portable terminal.

Thereafter, in step 309, the control server identifies registration information of the portable terminal. For example, the control server selects registration information on the terminal identifier of the portable terminal identified in step 307, among a plurality of pre-registered registration information elements. Herein, the registration information of the portable terminal includes a user identifier and a terminal identifier pre-registered in the portable terminal.

In step 311, based on the registration information of the portable terminal, the control server determines whether the user identifier matched to the terminal identifier is changed. That is, the control server determines whether the user identifier included in the registration information identified in step 309 is identical to the user identifier identified in step 307.

When the user identifier matched to the terminal identifier is not changed, the control server determines that the portable terminal is not lost. Accordingly, the control server returns to step 301 and determines again whether a terminal information identification event occurs.

On the other hand, when the user identifier matched to the terminal identifier is changed, the control server determines that the portable terminal is lost. Accordingly, the control server proceeds to step 313 and transmits loss information of the portable terminal to a predetermined emergency communication network. Herein, the loss information of the portable terminal includes at least one of the loss/non-loss of the portable terminal, position information registered last by the portable terminal, and the last use time of the portable terminal.

Thereafter, the control server ends the present algorithm.

In the above exemplary embodiment, when a terminal information identification event occurs, the control server requests terminal information from the portable terminal and identifies the loss/non-loss of the portable terminal by using the terminal information received from the portable terminal.

In another exemplary embodiment, as illustrated in FIG. 4, the control server may identify the loss/non-loss of the portable terminal by using terminal information received from the portable terminal, without making a separate request.

FIG. 4 illustrates a process for identifying the loss/non-loss of a portable terminal by the control server according to another exemplary embodiment of the present disclosure.

Referring to FIG. 4, in step 401, the control server determines whether terminal information is received from the portable terminal. For example, the control server determines whether terminal information is periodically received from the portable terminal.

When terminal information is received from the portable terminal, the control server proceeds to step 403. In step 403, the control server identifies a user identifier and a terminal identifier of the portable terminal through the terminal information received from the portable terminal.

Thereafter, in step 405, the control server identifies registration information of the portable terminal. For example, the control server selects registration information on the terminal identifier of the portable terminal identified in step 403, among a plurality of pre-registered registration information elements. Herein, the registration information of the portable terminal includes a user identifier and a terminal identifier pre-registered in the portable terminal.

In step 407, based on the registration information of the portable terminal, the control server determines whether the user identifier matched to the terminal identifier is changed. That is, the control server determines whether the user identifier received from the portable terminal and identified in step 403 is identical to the user identifier included in the registration information identified in step 405.

When the user identifier matched to the terminal identifier is not changed, the control server determines that the portable terminal is not lost. Accordingly, the control server returns to step 401 and determines whether terminal information is received from the portable terminal.

On the other hand, when the user identifier matched to the terminal identifier is changed, the control server determines that the portable terminal is lost. Accordingly, the control server proceeds to step 409 and transmits loss information of the portable terminal to a predetermined emergency communication network. Herein, the loss information of the portable terminal includes at least one of the loss/non-loss of the portable terminal, position information registered last by the portable terminal, and the last use time of the portable terminal.

Thereafter, the control server ends the present algorithm.

Although not illustrated in FIGS. 3 and 4, the control server may provide a loss management service with respect to the portable terminal after transmitting loss information of the portable terminal to the emergency communication network. For example, after transmitting loss information of the portable terminal to the emergency communication network, the control server interrupts all services for the lost portable terminal. In this case, the control server may interrupt all services of the portable terminal only when loss information on the portable terminal is registered by the user.

As another example, after transmitting loss information of the portable terminal to the emergency communication network, the control server may remotely control the lost portable terminal to detect the peripheral situations of the portable terminal. Specifically, the control server may detect the peripheral situations of the portable terminal by remotely driving at least one of a microphone, a camera, and a position estimation module of the portable terminal.

In the above exemplary embodiment, the control unit identifies the loss/non-loss of the portable terminal based on the user identifier and the terminal identifier received from the portable terminal.

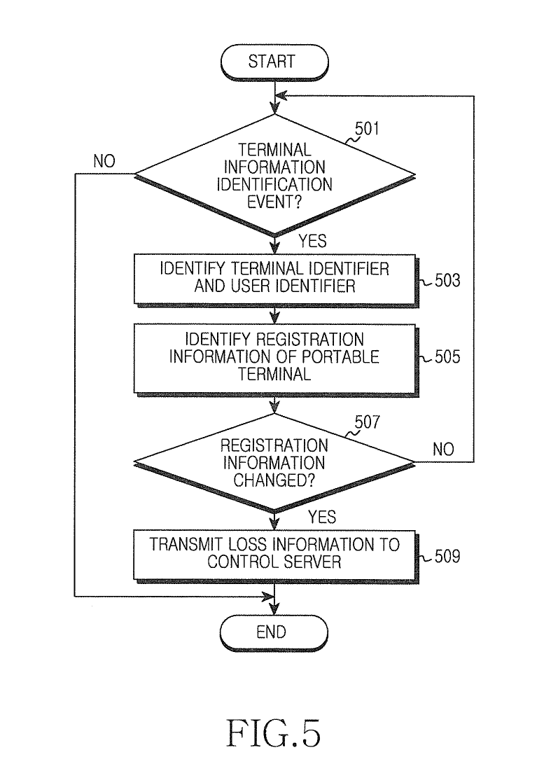

In another exemplary embodiment, as illustrated in FIG. 5, the portable terminal may identify the loss/non-loss of the portable terminal by using the user identifier and the terminal identifier of the portable terminal.

FIG. 5 illustrates a process for identifying the loss/non-loss of a portable terminal by the portable terminal according to an exemplary embodiment of the present disclosure.

Referring to FIG. 5, in step 501, the portable terminal determines whether a terminal information identification event occurs. For example, the portable terminal determines whether a terminal information transmission period arrives. In this case, when a terminal information transmission period arrives, the portable terminal determines that a terminal information identification event occurs. As another example, the portable terminal may determine whether the control server requests terminal information. In this case, when the control server requests terminal information, the portable terminal determines that a terminal information identification event occurs. As yet another example, the portable terminal may determine whether the power is on. In this case, when the power is newly turned on, the portable terminal determines that a terminal information identification event occurs. As yet another example, the portable terminal may determine whether a subscriber identification module (SIM) card is changed. In this case, when the SIM card is changed, the portable terminal determines that a terminal information identification event occurs.

When a terminal information identification event occurs, the portable terminal proceeds to step 503. In step 503, the portable terminal identifies a terminal identifier and a user identifier of the portable terminal. For example, through a SIM card inserted into the portable terminal, the portable terminal may identify a user identifier of a user that currently uses the portable terminal.

Also, when a terminal information identification event occurs, the portable terminal proceeds to step 505. In step 505, the portable terminal identifies registration information of the portable terminal. Herein, the registration information of the portable terminal includes a user identifier and a terminal identifier pre-registered in the portable terminal.

In step 507, the portable terminal determines whether the user identifier matched to the terminal identifier is changed. That is, the portable terminal determines whether the user identifier identified in step 503 is identical to the user identifier included in the registration information identified in step 505.

When the user identifier matched to the terminal identifier is not changed, the portable terminal determines that the portable terminal is not lost. Accordingly, the portable terminal returns to step 501 and determines again whether a terminal information identification event occurs.

On the other hand, when the user identifier matched to the terminal identifier is changed, the portable terminal determines that the portable terminal is lost and is used by another person for a wrong purpose. Accordingly, the portable terminal proceeds to step 509 and transmits loss information to the control server. Herein, the loss information includes at least one of the loss/non-loss of the portable terminal, position information identified last by the portable terminal, and the last use time of the portable terminal.

Thereafter, the portable terminal ends the present algorithm.

In the above exemplary embodiment, when a terminal information identification event occurs, the portable terminal identifies a terminal identifier and a user identifier (step 503).

In another exemplary embodiment, when a terminal information identification event occurs, the portable terminal may identify only a user identifier. Specifically, when the loss/non-loss of the portable terminal is identified by the portable terminal, the portable terminal stores only the portable terminal's own registration information. Accordingly, the portable terminal may identify a current user identifier, compare the current user identifier with a pre-registered user identifier, and determine the loss/non-loss of the portable terminal according to the comparison result.

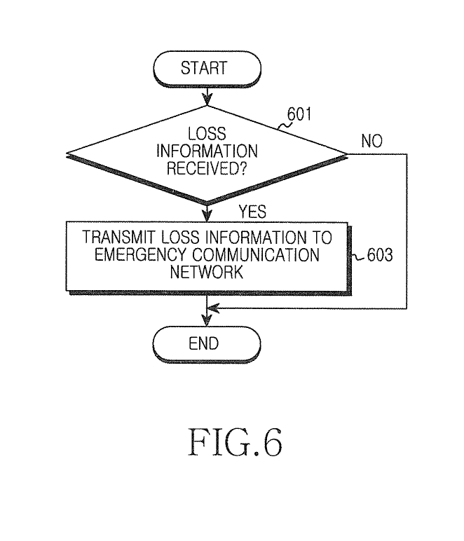

As described above, when determining the loss of the portable terminal, the portable terminal transmits loss information of the portable terminal to the control server. In this case, the control server transmits loss information of the portable terminal through an emergency communication network as illustrated in FIG. 6.

FIG. 6 illustrates a process for providing a loss management service by the control server according to an exemplary embodiment of the present disclosure.

Referring to FIG. 6, in step 601, the control server determines whether loss information is received from the portable terminal. Herein, the loss information includes at least one of the loss/non-loss of the portable terminal, position information registered last by the portable terminal, and the last use time of the portable terminal.

When loss information is received from the portable terminal, the control server proceeds to step 603. In step 603, the control server transmits loss information of the portable terminal to a predetermined emergency communication network.

Thereafter, the control server ends the present algorithm.

Although not illustrated, the control server may provide a loss management service for the portable terminal after transmitting loss information of the portable terminal to the emergency communication network. For example, after transmitting loss information of the portable terminal to the emergency communication network, the control server interrupts all services for the lost portable terminal. In this case, the control server may interrupt all services of the portable terminal only when loss information on the portable terminal is registered by the user.

As another example, after transmitting loss information of the portable terminal to the emergency communication network, the control server may remotely control the lost portable terminal to detect the peripheral situations of the portable terminal. Specifically, the control server may detect the peripheral situations of the portable terminal by remotely driving at least one of a microphone, a camera, and a position estimation module of the portable terminal.

In the above exemplary embodiment, when identifying the loss of the portable terminal based on the terminal identifier and the user identifier, the portable terminal transmits loss information to the control server.

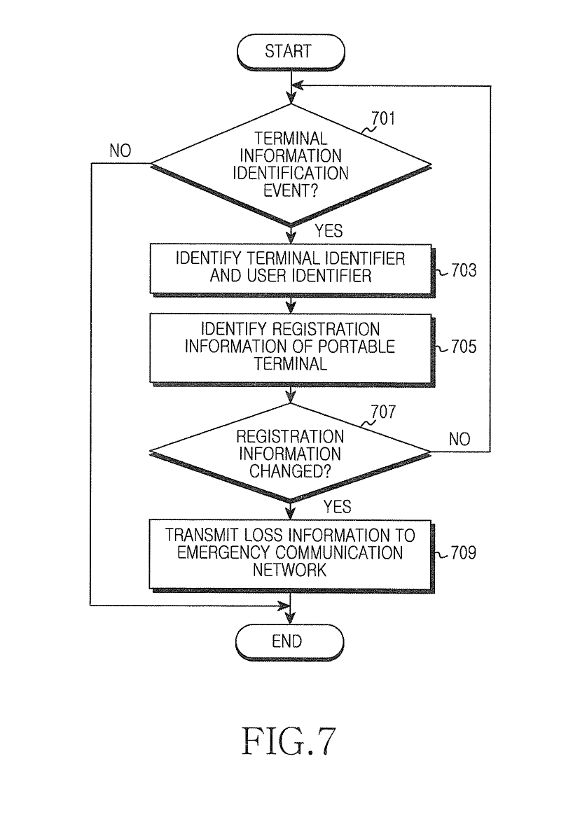

In another exemplary embodiment, when identifying the loss of the portable terminal based on the terminal identifier and the user identifier, the portable terminal may transmit loss information to the emergency communication network as illustrated in FIG. 7.

FIG. 7 illustrates a process for providing a loss management service by the portable terminal according to an exemplary embodiment of the present disclosure.

Referring to FIG. 7, in step 701, the portable terminal determines whether a terminal information identification event occurs. For example, the portable terminal determines whether a terminal information transmission period arrives. In this case, when a terminal information transmission period arrives, the portable terminal determines that a terminal information identification event occurs. As another example, the portable terminal may determine whether the control server requests terminal information. In this case, when the control server requests terminal information, the portable terminal determines that a terminal information identification event occurs. As yet another example, the portable terminal may determine whether the power is on. In this case, when the power is newly turned on, the portable terminal determines that a terminal information identification event occurs. As yet another example, the portable terminal may determine whether a subscriber identification module (SIM) card is changed. In this case, when the SIM card is changed, the portable terminal determines that a terminal information identification event occurs.

When a terminal information identification event occurs, the portable terminal proceeds to step 703. In step 703, the portable terminal identifies a terminal identifier and a user identifier. For example, through a SIM card inserted into the portable terminal, the portable terminal may identify a user identifier of a user that currently uses the portable terminal.

Also, when a terminal information identification event occurs, the portable terminal proceeds to step 705. In step 705, the portable terminal identifies registration information of the portable terminal. Herein, the registration information of the portable terminal includes a user identifier and a terminal identifier pre-registered in the portable terminal.

In step 707, based on the registration information of the portable terminal, the portable terminal determines whether the user identifier matched to the terminal identifier is changed. That is, the portable terminal determines whether the user identifier identified in step 703 is identical to the user identifier included in the registration information identified in step 705.

When the user identifier matched to the terminal identifier is not changed, the portable terminal determines that the portable terminal is not lost. Accordingly, the portable terminal returns to step 701 and determines whether a terminal information identification event occurs.

On the other hand, when the user identifier matched to the terminal identifier is changed, the portable terminal determines that the portable terminal is lost and is used by another person for a wrong purpose. Accordingly, the portable terminal proceeds to step 709 and transmits loss information of the portable terminal to a predetermined emergency communication network. Herein, the loss information includes at least one of the loss/non-loss of the portable terminal, position information identified last by the portable terminal, and the last use time of the portable terminal.

Thereafter, the portable terminal ends the present algorithm.

In the above exemplary embodiment, when a terminal information identification event occurs, the portable terminal identifies a terminal identifier and a user identifier (step 703).

In another exemplary embodiment, when a terminal information identification event occurs, the portable terminal may identify only a user identifier. Specifically, when the loss/non-loss of the portable terminal is identified by the portable terminal, the portable terminal stores only the portable terminal's own registration information. Accordingly, the portable terminal may identify a current user identifier, compare the current user identifier with a pre-registered user identifier, and determine the loss/non-loss of the portable terminal according to the comparison result.

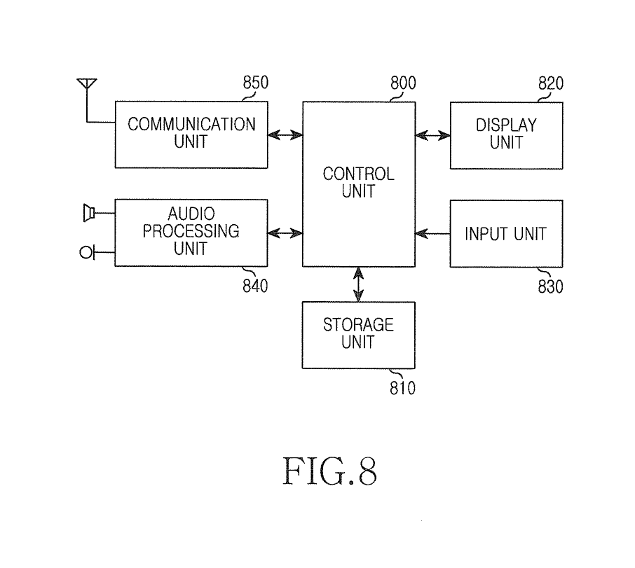

FIG. 8 illustrates a block diagram of a portable terminal according to the present disclosure.

Referring to FIG. 8, the portable terminal may include a control unit 800, a storage unit 810, a display unit 820, an audio processing unit 840, and a communication unit 850.

The control unit 800 controls an overall operation of the portable terminal.

The control unit 800 identifies the loss/non-loss of the portable terminal based on a terminal identifier of the portable terminal and a user identifier of the portable terminal. For example, as illustrated in FIG. 1, the control unit 800 connects to a control server by a user operation and registers at least one of terminal information, loss management information, and a user password.

As another example, by a user operation, the control unit 800 may change or delete at least one of terminal information, loss management information, and a user password that are registered in the control server.

As yet another example, as illustrated in FIG. 2, when a terminal information identification event occurs, the control unit 800 identifies the user identifier and the terminal identifier of the portable terminal and transmits the same to the control server.

As yet another example, as illustrated in FIG. 5, when a terminal information identification event occurs, the control unit 800 identifies the user identifier and the terminal identifier of the portable terminal. Thereafter, the control unit 800 identifies the loss/non-loss of the portable by identifying whether the user identifier of registration information of the portable terminal stored in the storage unit 810 is changed. When identifying the loss of the portable terminal, the control unit 800 transmits loss information of the portable terminal to the control server. Herein, the registration information of the portable terminal includes the user identifier and the terminal identifier of the portable terminal.

As yet another example, as illustrated in FIG. 7, when a terminal information identification event occurs, the control unit 800 identifies the user identifier and the terminal identifier of the portable terminal. Thereafter, the control unit 800 identifies the loss/non-loss of the portable by identifying whether the user identifier of registration information of the portable terminal stored in the storage unit 810 is changed. When identifying the loss of the portable terminal, the control unit 800 transmits loss information of the portable terminal to an emergency communication network stored in the storage unit 810. Herein, the registration information of the portable terminal includes the user identifier and the terminal identifier of the portable terminal.

The storage unit 810 may include a program storage unit for storing a program for controlling an operation of the portable terminal, and a data storage unit for storing data generated during the execution of a program. For example, the storage unit 810 stores the emergency communication network and the registration information of the portable terminal.

Under the control of the control unit 800, the display unit 820 displays status information of the portable terminal, characters input by a user, moving pictures, still pictures, and the like. For example, the display unit 820 may include a touchscreen that has both an information display function and an input function.

The input unit 830 provides the control unit 800 with input data generated by user selection. For example, when the display unit 820 includes a touchscreen, the input unit 830 may include only one or more control buttons for controlling the portable terminal. As another example, the input unit 830 may include a keypad for receiving input data from the user.

The audio processing unit 840 controls the input/output of audio signals. For example, the audio processing unit 840 outputs an audio signal received from the control unit 800 to the outside through a speaker, and provides an audio signal received from a microphone to the control unit 800.

The communication unit 850 processes signals transmitted/received through an antenna for voice and data communication.

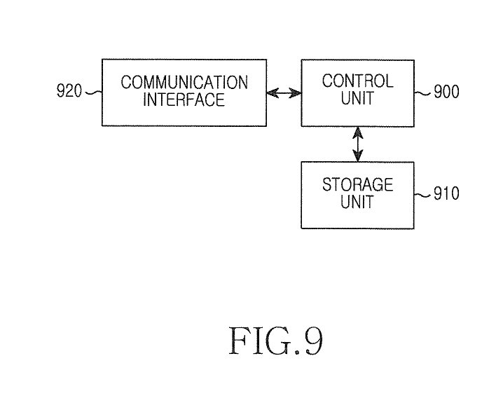

FIG. 9 illustrates a block diagram of a control server according to the present disclosure.

Referring to FIG. 9, the control server may include a control unit 900, a storage unit 910, and a communication interface 920.

The control unit 900 controls an overall operation of the control server.

The control unit 900 identifies the loss/non-loss of a portable terminal based on a terminal identifier and a user identifier received from the portable terminal. For example, as illustrated in FIG. 3 or 4, the control unit 900 identifies the loss/non-loss of a portable terminal by comparing a terminal identifier and a user identifier received from the portable terminal with pre-registered registration information of the portable terminal. When identifying the loss of the portable terminal, the control unit 900 transmits loss information of the portable terminal to an emergency communication network stored in the storage unit 910. Herein, the registration information of the portable terminal includes the user identifier and the terminal identifier of the portable terminal.

As another example, as illustrated in FIG. 6, when receiving loss information from the portable terminal, the control unit 900 transmits the loss information of the portable terminal to an emergency communication network stored in the storage unit 910.

The storage unit 910 may include a program storage unit for storing a program for controlling an operation of the control server, and a data storage unit for storing data generated during the execution of a program. For example, the storage unit 910 stores the emergency communication network and the registration information of the portable terminal.

The communication interface 920 processes signals communicated with the portable terminal.

As described above, the present disclosure identifies the loss/non-loss of a portable terminal in a wireless communication system by using matching information on a terminal identifier and a user identifier of the portable terminal, and transmits loss information of the portable terminal through an emergency communication network, thereby making it possible to easily detect the loss of the portable terminal.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for identifying a loss of a portable terminal by a control server in a wireless communication system, the method comprising:
receiving a user identifier from the portable terminal;
identifying registration information of the portable terminal; and
determining that the portable terminal is lost, when the user identifier received from the portable terminal is different from the registration information of the portable terminal,
wherein the registration information of the portable terminal includes a pre-registered user identifier of the portable terminal.

2. The method of claim 1, wherein receiving the user identifier from the portable terminal comprises receiving a user identifier of the portable terminal that is transmitted by the portable terminal by using unstructured supplementary service data (USSD).

3. The method of claim 1, wherein the user identifier includes an international mobile subscriber identity (IMSI).

4. The method of claim 1, wherein identifying the registration information of the portable terminal comprises:
identifying a terminal identifier of the portable terminal; and
selecting registration information on the terminal identifier among a plurality of pre-registered registration information elements.

5. The method of claim 1, further comprising:
identifying an emergency communication network for the portable terminal when the portable terminal is lost; and
transmitting loss information of the portable terminal to the emergency communication network.

6. The method of claim 5, wherein the loss information of the portable terminal includes at least one of the loss/non-loss of the portable terminal, position information registered by the portable terminal, and a last use time of the portable terminal.

7. A method for identifying a loss of a portable terminal by the portable terminal in a wireless communication system, the method comprising:
identifying a user identifier of the portable terminal;
identifying registration information of the portable terminal; and
determining that the portable terminal is lost, when the user identifier is different from the registration information of the portable terminal,
wherein the registration information of the portable terminal includes a pre-registered user identifier of the portable terminal.

8. The method of claim 7, wherein the user identifier includes an international mobile subscriber identity (IMSI).

9. The method of claim 7, further comprising:
identifying an emergency communication network when the portable terminal is lost; and
transmitting loss information of the portable terminal to the emergency communication network.

10. The method of claim 9, wherein the loss information of the portable terminal includes at least one of the loss/non-loss of the portable terminal, position information registered by the portable terminal, and a last use time of the portable terminal.

11. The method of claim 7, further comprising transmitting loss information of the portable terminal to a control server when the portable terminal is lost.

12. An apparatus in a control server configured to identify a loss of a portable terminal by a control server in a wireless communication system, the apparatus comprising:
a communication interface configured to receive a user identifier from the portable terminal;
a storage unit configured to store registration information of the portable terminal; and
a control unit configured to determine that the portable terminal is lost, when the user identifier received from the portable terminal through the communication interface is different from the registration information of the portable terminal stored in the storage unit,
wherein the registration information of the portable terminal includes a pre-registered user identifier of the portable terminal.

13. The apparatus of claim 12, wherein the communication interface is configured to receive a user identifier of the portable terminal that is transmitted by the portable terminal by using unstructured supplementary service data (USSD).

14. The apparatus of claim 12, wherein the user identifier includes an international mobile subscriber identity (IMSI).

15. The apparatus of claim 12, wherein the control unit is configured to identify a terminal identifier of the portable terminal and select registration information on the terminal identifier among a plurality of pre-registered registration information elements.

16. The apparatus of claim 12, wherein when the portable terminal is lost, the communication interface is configured to transmit loss information of the portable terminal to an emergency communication network for the portable terminal stored in the storage unit.

17. The apparatus of claim 16, wherein the loss information of the portable terminal includes at least one of the loss/non-loss of the portable terminal, position information registered by the portable terminal, and a last use time of the portable terminal.

18. An apparatus in a portable terminal configured to identify a loss of the portable terminal, the apparatus comprising:
a storage unit configured to storing registration information of the portable terminal; and
a control unit configured to identifying a user identifier of the portable terminal and determining that the portable terminal is lost, when the user identifier is different from the registration information of the portable terminal stored in the storage unit,
wherein the registration information of the portable terminal includes a pre-registered user identifier of the portable terminal.

19. The apparatus of claim 18, wherein the user identifier includes an international mobile subscriber identity (IMSI).

20. The apparatus of claim 18, further comprising a communication interface configured to transmit loss information of the portable terminal to an emergency communication network stored in the storage unit, when the portable terminal is lost.

21. The apparatus of claim 20, wherein the loss information of the portable terminal includes at least one of the loss/non-loss of the portable terminal, position information registered last by the portable terminal, and the last use time of the portable terminal.

22. The apparatus of claim 18, further comprising a communication interface configured to transmit loss information of the portable terminal to a control server when the portable terminal is lost.
